(19) United States
(12) Patent Application Publication
(10) Pub. No.: US 2024/0061406 A1
(43) Pub. Date: Feb. 22, 2024

(54) ROBOT CONFIGURATION SYSTEM AND METHOD

(71) Applicant: Viam Inc., New York, NY (US)

(72) Inventors: Eliot Horowitz, New York, NY (US); Eric Daniels, New York, NY (US)

(21) Appl. No.: 18/386,045

(22) Filed: Nov. 1, 2023

Related U.S. Application Data
(63) Continuation-in-part of application No. 18/138,963, filed on Apr. 25, 2023.
Application No. 18/138,963 is a continuation-in-part of application No. PCT/US23/19760, filed on Apr. 25, 2023.
(60) Provisional application No. 63/335,615, filed on Apr. 27, 2022.
(60) Provisional application No. 63/406,040, filed on Sep. 13, 2022.
(60) Provisional application No. 63/436,793, filed on Jan. 3, 2023.
(60) Provisional application No. 63/335,615, filed on Apr. 27, 2022.
(60) Provisional application No. 63/406,040, filed on Sep. 13, 2022.
(60) Provisional application No. 63/436,793, filed on Jan. 3, 2023.

(51) Int. Cl. G05B 19/418

(52) U.S. Cl. CPC G05B 19/4186; G05B 19/41835

(57) ABSTRACT

In variants, a robot system can include a set of robot parts that communicate using a response-request framework.

### CROSS-REFERENCE TO RELATED APPLICATIONS

This application is a continuation in part of Ser. No. 18/138,963 filed 25 Apr. 2023 and PCT Application No. PCT/US23/19760 filed 25 Apr. 2023, both of which claims the benefit of U.S. Provisional Application No. 63/335,615 filed 27 Apr. 2022, U.S. Provisional Application No. 63/406,040 filed 13 Sep. 2022, and U.S. Provisional Application No. 63/436,793 filed 3 Jan. 2023, each of which is incorporated in its entirety by this reference.

### TECHNICAL FIELD

This invention relates generally to the devices field, and more specifically to a new and useful device control architecture in the devices field.

### BRIEF DESCRIPTION OF THE FIGURES

FIG. 1 is a schematic representation of a variant of the device control system.

FIG. 2 is a schematic representation of a variant of a virtual representation of an example device including a set of parts, wherein each part includes a set of resources.

FIG. 3 is a schematic representation of an example device with different communication framework types.

FIG. 4 is a schematic representation of an example of device operation.

FIG. 5 is a schematic representation of an illustrative example of device operation.

FIG. 6 is an illustrative example of a configuration file and use thereof.

FIGS. 7A and 7B depict illustrative examples of devices.

FIG. 8 depicts an illustrative example of a configuration file.

FIG. 9 depicts an illustrative example of a configuration interface.

FIG. 10 is a schematic representation of a variant of the method.

FIG. 11 is an illustrative example of initializing a device part.

FIG. 12 is an illustrative example of operating a device part.

FIG. 13 is an illustrative example of various ways that device elements can be registered.

FIG. 14 is an illustrative example of how a persistent communication channel is created between part elements.

FIGS. 15A, 15B, and 15C-15D are an illustrative example of a control interface for controlling a part including arm and a subcomponent motor, an illustrative example of a program to control the part, and illustrative examples of the subcomponent motor state during program execution, respectively.

### DETAILED DESCRIPTION

The following description of the embodiments of the invention is not intended to limit the invention to these embodiments, but rather to enable any person skilled in the art to make and use this invention.

1. Overview.

In variants, the device system can include a set of device parts 200 that communicate using a response-request framework.

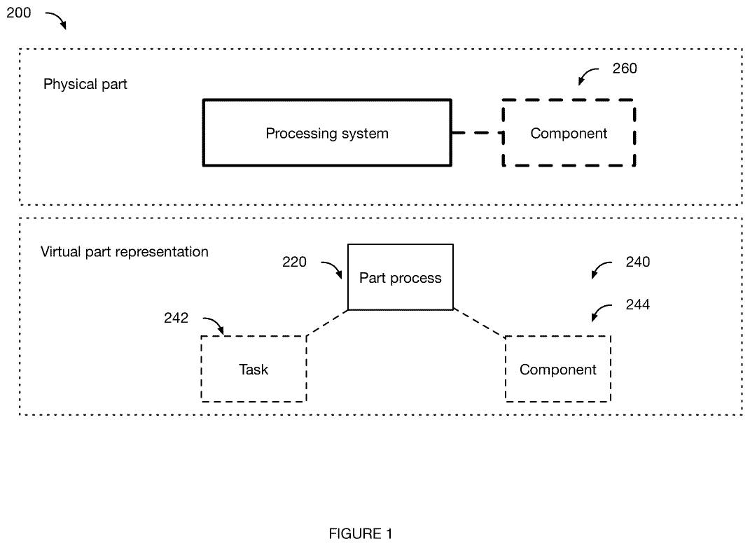

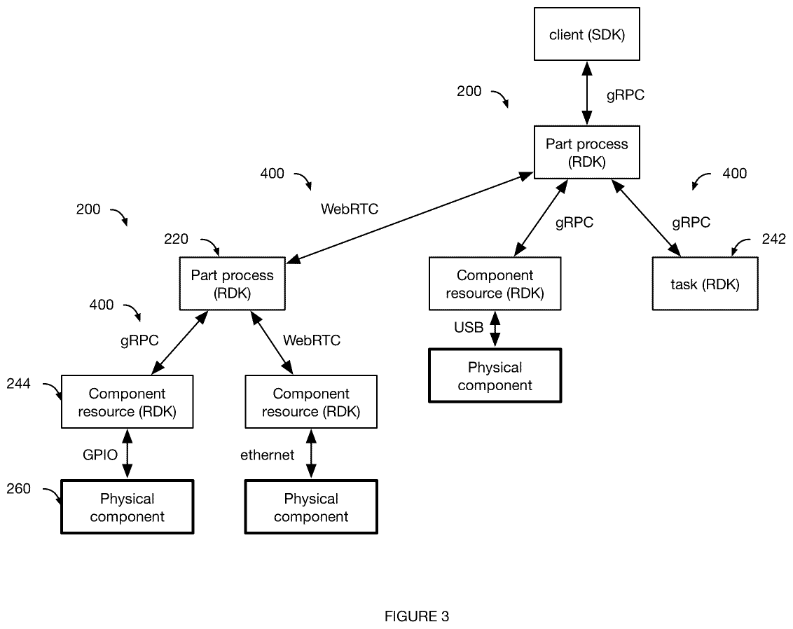

In an example, the system can include or interface with a set of devices 100. Each device 100 can include one or more parts 200. The parts 200 can communicate with each other and/or remote systems (e.g., other devices, other device parts, remote clients, cloud systems, etc.) using a request-response message passing framework (e.g., WebRTC, gRPC, Websockets, other protocols, etc.). For example, the parts 200 can communicate over long-lived channels established using the request-response protocol (e.g., example shown in FIG. 3). Each part 200 can include at least one processing system, and can optionally include one or more physical components 260 (example shown in FIG. 1). Each part 200 can also be associated with (e.g., run, execute, etc.) a part process 220 (e.g., a single part process) and a set of resources 240 (example shown in FIG. 1). The set of resources 240 can include: one or more task resources 242, each associated with a set of task logic; one or more component resources 244, each configured to interact with a respective physical component 260; and/or other resources.

In further examples, elements of the system (e.g., devices, parts, components, tasks, cloud platform, etc.) can conform to a system-standard interface (e.g., programming interface), and generate and/or respond to requests using a set of method calls that are standard to the interface. In an illustrative example, different device parts 200 can receive the same calls in the system-standard ontology or syntax and provide the same result (e.g., component control, measurement, etc.) despite having different physical components.

However, the system can be otherwise structured.

2. Technical Advantages

Variants of the technology can enable several advantages over conventional device control frameworks, such as ROS.

First, variants of the technology can use Internet communication protocols (e.g., WebRTC, gRPC, WebSockets, HTTP versions, etc.) to implement communications between individual device parts on the same device or different devices. This enables common developers with no prior hardware or roboticists experience to easily program devices, which previously was only accessible to trained roboticists with decades of experience.

Furthermore, using these protocols enables the system to access the attendant security, stability, extensibility, and functionalities that have been built for the protocols (e.g., RPC protocols, WebRTC, etc.). For example, variants of the technology can reduce communication lag by establishing peer-to-peer connections (e.g., without intermediary brokers or servers), and can enjoy communication encryption conferred by these protocols.

Using these protocols also enables both the devices and the device parts to natively and seamlessly interface with both local and remote systems (e.g., cloud services, mobile clients, etc.), which can enable: remote management (e.g., software updates, etc.), remote monitoring, remote control (e.g., of devices or individual components), remote updates, remote data management, and/or other functionalities. In an illustrative example, in addition to (or instead of) running the device software locally, the device software can also run remotely (e.g., from anywhere), wherein the device or device part commands output by the software are sent to the respective endpoint using said protocols.

Second, variants of the technology can make device programming: hardware model agnostic (e.g., manufacturer agnostic), make the system more extensible, enable programmers to write predictable, reliable, and consistent code (e.g., in any programming language), and/or confer other benefits by abstracting hardware into higher-level component types (e.g., “arm” or “motor”), providing a set of system-standard component class calls, and providing a set of component-specific submodules that convert the system-standard component class calls to component-specific calls (e.g., driver calls). In illustrative examples, ‘MoveToJointPosition’ moves any arm, and ‘SetPower’ turns on any motor.

However, further advantages can be provided by the system and method disclosed herein.

3. System.

The system can include a set of devices 100. A device 100 is preferably physical (e.g., and acts on the physical world), but can alternatively be virtual. Examples of devices can include: robots, IOT devices, autonomous vehicles, and/or other devices.

Each device 100 can include a set of parts 200 (device parts, edge computing device, etc.). Each device can include one or more, two or more, three or more, and/or any other suitable number of parts. The parts of each device are preferably physically connected together, but can alternatively not be connected together. In examples, the parts can be mounted to each other, mounted to a common part, mounted to a common base, indirectly mounted to each other, and/or otherwise connected to each other.

The device part 200 is preferably a physical part, but can alternatively be virtual. Each device part can function as a modular resource that can be individually (e.g., directly) programmed, accessed, and/or controlled, but can alternatively be indirectly operated (e.g., through a master part, through a central processing system, etc.).

Each device part 200 can use one or more communication frameworks (e.g., communication protocol) to establish one or more connections with one or more: other device parts on the same device, remote endpoints, and/or any other suitable endpoint. Examples of remote endpoints can include: other device parts on other devices, other devices (e.g., from the same or different fleet), remote computing systems (e.g., cloud services), user devices (e.g., smartphones, laptops, etc.), remote clients (e.g., browsers, mobile applications, native applications, devices, etc.), and/or any other suitable remote endpoint.

The communication framework is preferably a request-response communication protocol, such as WebRTC, gRPC, WebSockets, HTTP, and/or another request-response protocol, but can additionally or alternatively be a communication protocol provided by the physical inter-hardware (e.g., inter-component, processing unit-to-component, etc.) connections (e.g., HDMI, USB, etc.), and/or be any other suitable communication protocol (e.g., discussed below). In an example, inter-part communication can use a request-response communication protocol, and intra-part communication (e.g., between the part process and components of the same part) can use the component's hardware connection protocol. The communication framework can be used to establish long-lived (e.g., persistent) communication channels between the device part and the endpoint(s), but can alternatively be otherwise used. A long-lived communication channel can be used for (e.g., support) multiple request-response interactions without reinitialization, but can be otherwise defined.

Each device part 200 can function as a client, as a server, or both. In a first example, each device part 200 (e.g., the processing system, communications module, etc.) can host a server (e.g., configured to receive and/or generate messages from clients and/or other servers). In a second example, each device part 200 (e.g., the processing system) can host a client (e.g., configured to receive and/or generate messages from other clients and/or servers). In a third example, each device part 200 can host both a server and a client configured to communicate with the servers and/or clients of other device parts, remote computing systems, and/or other system elements (e.g., the device part 200 can use the client to send requests to the servers of other system elements and use the server to respond to requests from clients of other system elements). In an illustrative example, each device part 200 and/or remote endpoint can host a gRPC server and/or a gRPC client. In a second illustrative example, each device part 200 and/or remote endpoint can host a WebRTC server and/or a WebRTC client. In a third illustrative example, each device part 200 and/or remote endpoint can host both a gRPC server and WebRTC server and/or host a gRPC client and a WebRTC client. However, the device part 200 can be otherwise configured. Similarly, other system elements (e.g., remote computing system, etc.) can include (e.g., host) a server and/or client for one or more communication architectures and/or protocols.

Each device part 200 can establish one or more communication channels 400 (e.g., communication connections) with one or more endpoints at the same or different times. The same communication protocol is preferably used to establish all connections with a given device part; alternatively, different connections can be established with the device part using different communication protocols (e.g., the device part can have heterogeneous connections). In the latter variant, the communication protocol that is used can be automatically determined, manually determined (e.g., by the programmer, etc.), determined based on the endpoint's characteristics (e.g., whether the endpoint has sufficient processing power or bandwidth to support the resultant communication channel), and/or otherwise determined.

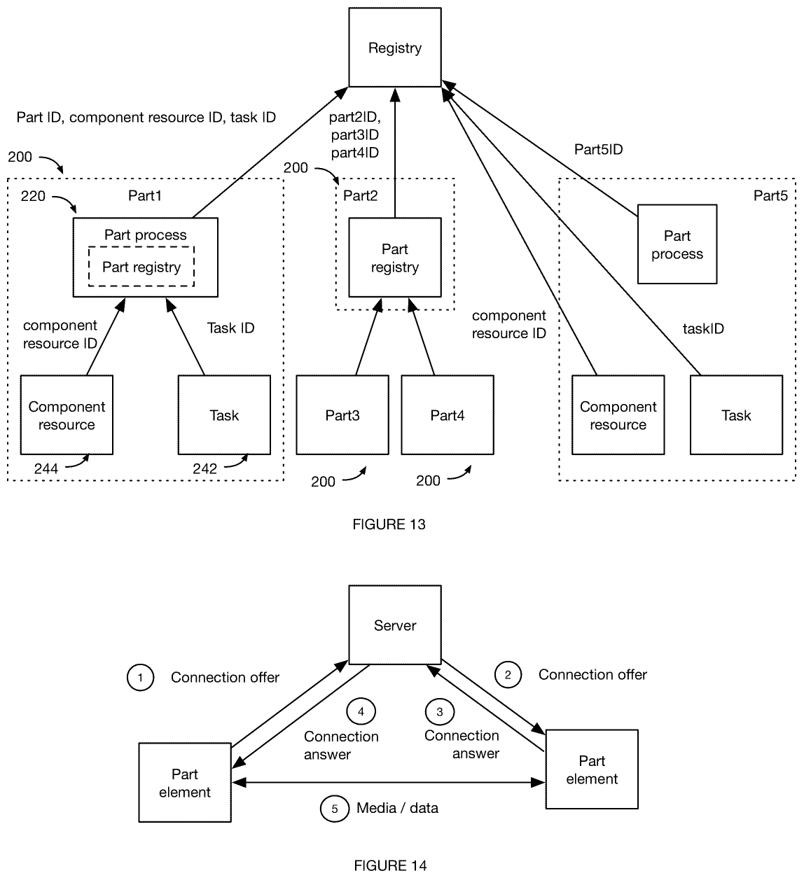

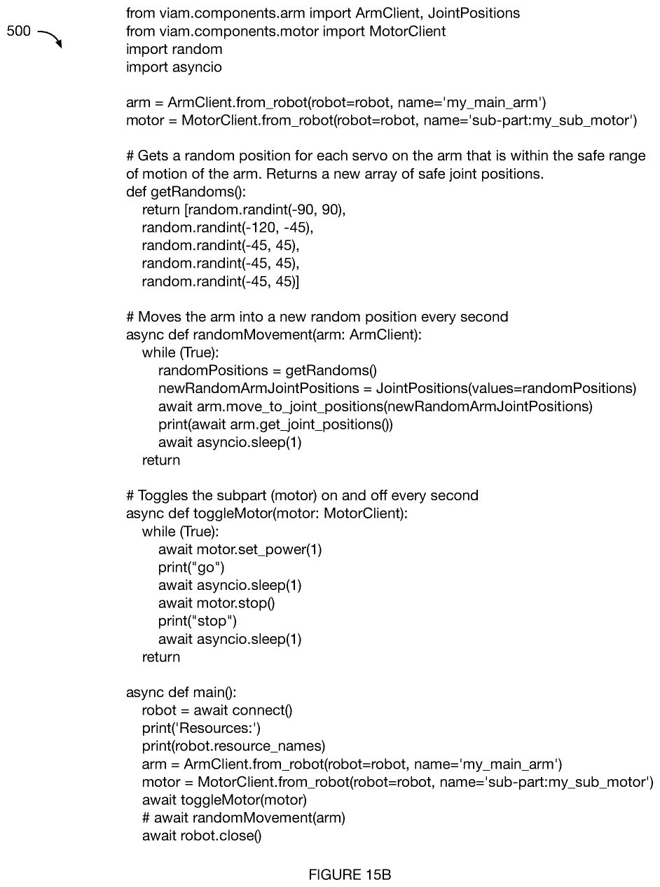

The device part 200 can receive and/or send data over the connection(s) 400. Examples of data that can be communicated include: messages, payloads, historical data, and/or other information (e.g., examples shown in FIG. 12 and FIG. 14). Messages can include requests, responses, and/or other messages. Messages can be from the part or from the connected endpoint. Examples of requests can include: service calls (e.g., task calls), component calls, control instructions, and/or other requests. Examples of responses can include: acknowledgements, payloads, execution completion confirmation, and/or other responses. Examples of payloads can include: sensor measurements (e.g., individual measurements, streams, etc.), part states (e.g., for a single time point, time series thereof, etc.), component states, analysis results (e.g., logs), software updates (e.g., new device configurations, etc.; signed and/or encrypted by a trusted entity; etc.), and/or other payloads. However, any other suitable data can be communicated over the connection.

Each device part 200 can be controlled by its own processing system, by a master part of the device, by a remote endpoint (e.g., remote client), and/or by any other suitable system. Each part can operate online (e.g., connected to the internet) or offline (e.g., without an internet connection, without an external wireless connection, etc.). Each part can be independently controlled, be controlled as part of a set, or be otherwise controlled. When the part is controlled as part of a set, the same control instructions (e.g., service calls, component calls, etc.) can be sent to each part of the set, or be otherwise controlled. The set can include: a subset of parts on the same device, set of parts from different devices (e.g., sharing a common parameter, such as the same component type), and/or be otherwise defined.

As shown in FIG. 1, each device part 200 can include a processing system, and can optionally include one or more physical components 260.

The processing system functions to communicate with other elements (e.g., other parts, the remote computing system, etc.), execute task logic, control any connected components (e.g., generate component control instructions), interpret component outputs, execute higher-level logic (e.g., process task and/or component outputs), store credentials (e.g., security keys, secret keys, API tokens, etc.), and/or perform other functionalities. Each part preferably includes a single processing system (e.g., compute unit), but can alternatively include multiple processing systems. Examples of processing systems can be used include: include: CPUs, GPUs, TPUs, IPUs, ASICs, microprocessors, single-board processors, low-powered processing systems (e.g., lower-powered than microprocessors), and/or other suitable components. The processing system can be associated with (e.g., identified by) an address (e.g., MAC address, IP address, etc.), a semantic identifier (e.g., user-defined identifier, automatically-defined identifier), or be otherwise identified. The processing system is preferably specific to the device part, but can alternatively be shared between device parts (e.g., be processes, containers, virtual machines, partitions, or other computing environments executing on the same bare metal).

The physical component 260 (“component”) functions to interact with the physical world. Each device part 200 can include one or more physical components 260. The physical component 260 is preferably physically connected to the processing system of the part 200, but can alternatively be operably or communicably connected to the processing system and/or otherwise associated with the processing system. The physical component 260 can optionally have its own compute (e.g., its own microprocessor, separate from the part processing system); alternatively, the component's compute can be the part's processing system and/or vice versa. The physical component 260 can be associated with (e.g., identified by) an address (e.g., MAC address, IP address, etc.), a semantic identifier (e.g., user-defined identifier, automatically-defined identifier), or be otherwise identified. Examples of physical components can include: camera, force sensor, gantry, GPS, suction cup, IMU, accelerometer, gyroscope, LIDAR, RADAR, audio sensor, light sensor, temperature sensor, input (e.g., user input), arm, gripper, base, motor, servo, board, encoder, input controller, kinematic sensor, sensor, and/or any other suitable component.

Each component can, itself, optionally include components (e.g., subcomponents). For example, an arm component can include individual sensors (e.g., multiple encoders). In these situations, each component can be treated individually (e.g., the part includes an arm component and multiple encoder components), or be treated as a singular component (e.g., the part includes an arm component). The distinction on how to treat the components (e.g., individually or as a package) can be determined by: the programmer, automatically (e.g., wherein each component package received from the manufacturer is treated as a singular package), and/or otherwise determined.

The physical component 260 can be associated with a hardware class, a component model, and/or any other suitable descriptor.

Hardware classes can include inputs (e.g., sensors), outputs (e.g., actuators), connectors (e.g., boards), reference frames (e.g., base), and/or other hardware classes. Examples of hardware classes that can be used include: camera, force sensor, gantry, GPS, suction cup, IMU, accelerometer, gyroscope, LIDAR, RADAR, audio sensor, light sensor, temperature sensor, input (e.g., user input), arm, gripper, base, motor, servo, board, encoder, input controller, kinematic sensor, sensor, and/or any other suitable hardware class. Each hardware class can be associated with a different package (e.g., method library), defining different predefined methods (e.g., calls) for the respective hardware class.

Each component 260 can be associated with a component model (“component versions”), which can specify the specific make and/or model of the hardware class that is being used. Examples of component models include: ViperX 300 arm from Trossen Robotics™ (e.g., vx300s), WidowX 250 arm from Trossen Robotics™ (e.g., wx250s), Arduino™ boards, Raspberry Pi™ boards, and/or any other suitable component models.

Each component 260 can additionally or alternatively be associated with one or more drivers. The drivers can convert commands into low-level component instructions (e.g., machine instructions), and/or convert component outputs into higher-level data (e.g., convert signals into measurement values). The commands can be in the system-standard interface language (e.g., from the Viam™ API), in a web standard language (e.g., Python™, Java™, etc.), in a manufacturer-selected language, and/or in any other suitable language. The command language is preferably consistent and unified, regardless of the programming language or execution hardware (e.g., compute type), but can alternatively vary based on the programming language, the execution hardware, and/or otherwise vary.

Each component model can be associated with a sub-package or subset of methods—specific to said component model—in the component class package, wherein the component model subpackage can enable additional or alternative arguments or attributes (e.g., component model-specific attributes) that can be used.

In variants, the component model's sub-package can translate between the system-standard commands (e.g., system-standard calls, system-standard API calls, etc.) and the driver commands, which enables the respective component to respond to the system-standard commands in the expected manner. The component's output can be interpreted into a system-standard format by the driver, the component model's sub-package, by another module, and/or not interpreted into the system-standard format (e.g., provided in a raw, component-native format).

The device parts 200, device components 260, processing systems, and/or other device or system elements can be connected using a set of wired power and/or data connectors (e.g., physical connectors) and/or wireless connections. For example, the physical actuator can be connected to the device part's processing system via a wired connector; the main part can be connected to all or a subset of the child components on the same robot by a wired connector or by a wireless connection; and/or the system elements can be otherwise connected together. Examples of power and/or data connectors that can be used include: Ethernet, USB (e.g., USB-A, USB-C, microUSB, etc.), GPIO, SATA, and/or any other power and/or data connector. Examples of wireless connections can include: WiFi, Bluetooth, BLE, Zigbee, cellular (e.g., 4 G, 5G, etc.), and/or any other wireless connection. Different sets of device parts and/or components can be connected using different connections.

The device 100 can additionally or alternatively be associated with one or more security credentials. Examples of security credentials include: login credentials, security keys (e.g., secret keys, symmetric keys, public keys, private keys, etc.), API tokens, and/or any other suitable security asset. The security assets can be used for authentication (e.g., to authenticate requests), authorization (e.g., to authorize connections), signatures (e.g., to sign messages), encryption (e.g., to encrypt payloads, etc.), validation (e.g., to validate signatures, etc.), used to send the response (e.g., to sign the response, encrypt the response, etc.), and/or otherwise used. Each device, part, component, task, and/or any other suitable device element can be associated with and/or store the same or different security credentials. The security credentials can be provisioned: during manufacture, periodically, by the platform, when the communication connection is established, and/or at any other time, by any suitable party. In an example, a part can authenticate a request to download a package update using a first security key, send a request for the package updates to the package source using a second key, and authenticate that the package updates are from a trusted source (e.g., the fleet entity) before extracting and installing the packages (e.g., a binary) using a third key. However, the security assets can be otherwise used.

Each device 200 can be computationally represented as a set of virtual parts (“device part representation”). As shown in FIG. 1, each virtual part preferably corresponds to a different physical device part, but can alternatively correspond to multiple physical device parts, a subset of a physical device part, and/or any other set of physical device parts.

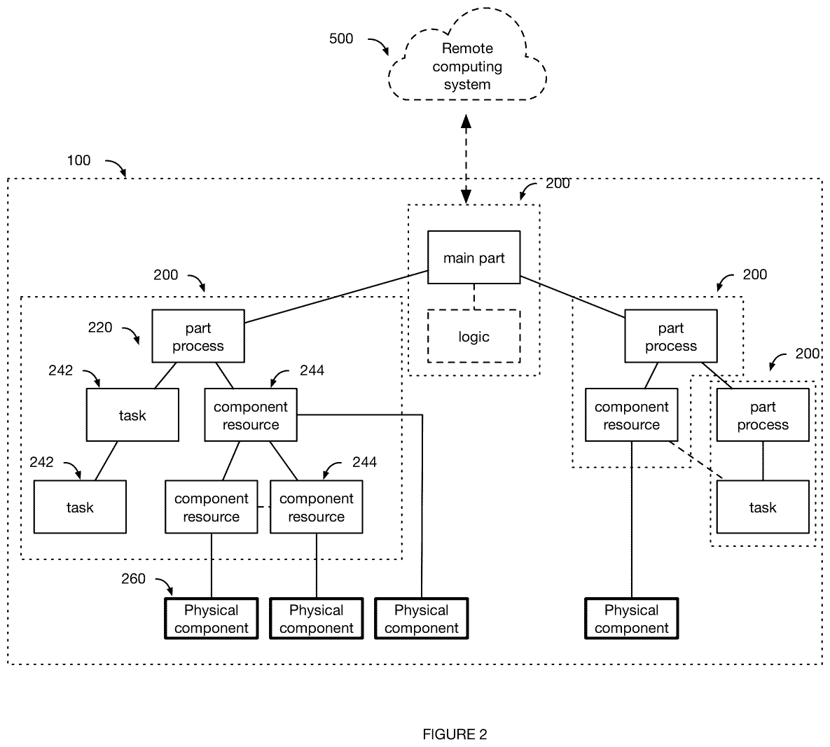

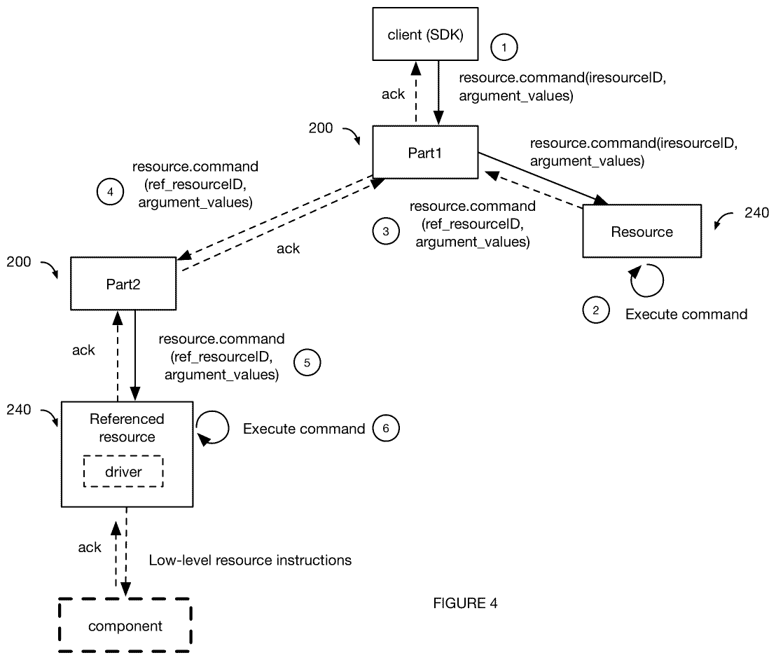

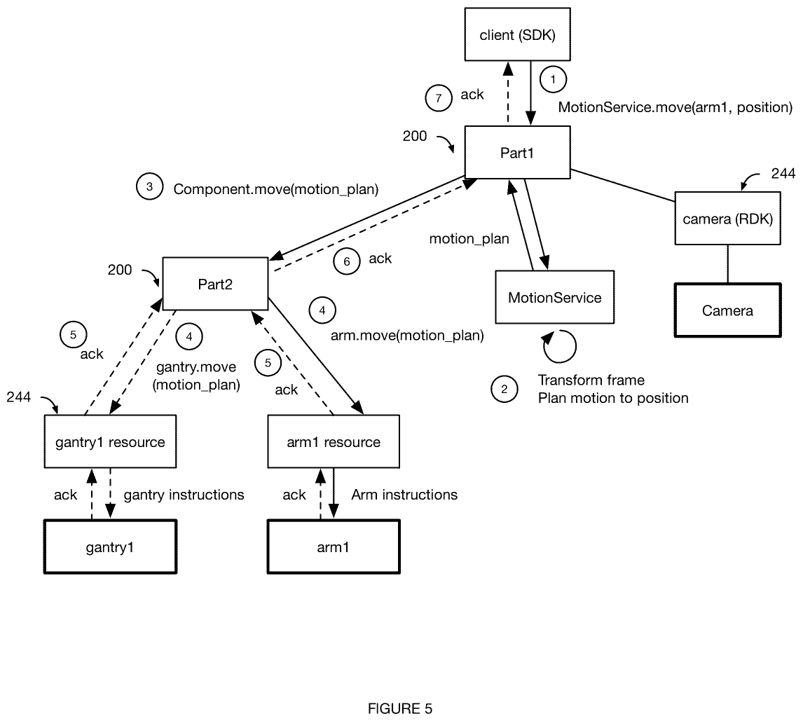

Different virtual parts within the same device can be organized in a hierarchy or tree, with a main part (“root part”) and one or more generations of child parts (examples shown in FIG. 2, FIG. 3, FIG. 4, and FIG. 5). In this variant, parent parts can register child parts (e.g., function as the signaling server, etc.), expose the constituent elements of said child parts (e.g., the part processes, the tasks, the component resources, etc.) to other elements of the system, facilitate peer-to-peer connections between the child part and another part, forward messages to the child parts, and/or otherwise interact with the child parts. The part dependency can be specified by a configuration file, by physical inter-part connections, randomly, and/or otherwise determined. The main part can be the part with an external connection (e.g., WiFi chipset, cellular chipset, remote computing system connection, etc.), be a part with the most computational power (e.g., processing power, memory, etc.), be a part specified by the configuration file, be a randomly selected part, be a manually identified part, and/or be otherwise determined. The master part can function as a signaling server, as a gateway (e.g., external gateway), as the main processing system (e.g., central controller for the rest of the device parts), and/or play any other suitable role. The master part preferably has a physical part corollary, but can alternatively have no physical corollary. Alternatively, the virtual parts can be organized as a pool, a mesh, and/or otherwise organized.

References to “part” and “component” can refer to “virtual part” and “component resource”, respectively, but can additionally or alternatively refer to the physical part and physical components.

Each part 200 (e.g., physical part, virtual part) can be associated with a set of services. Each service can provide a discrete unit of functionality, and/or be otherwise defined. Each service can be accessed remotely, only accessible locally (e.g., by the processes executing on a shared computing system), and/or otherwise accessible. Each service can be independently executed or executed as part of a set. Each part can include one or more services of the same or different type. Each service (e.g., “virtual part element”) is preferably a process executing on the processing system of the respective physical part, but can additionally or alternatively wholly or partially execute in a remote computing system, on another physical part's processing system, and/or on any other suitable system. Each part and associated services can be represented as a single unit or node, as a subtree of units or nodes, and/or be otherwise represented.

The services can include: part processes 220, resources 24o, and/or other services.

The part process 220 (“viam-server process”) functions as an interface between the remainder of the system (e.g., other parts, other devices, the remote computing system(s)) and the resources (e.g., components, tasks, etc.) associated with the part process. The part process 220 can control resource execution (e.g., orchestrate resource execution; determine which of the part's resources are executed at what time; etc.), function as a local registry (e.g., to register components of the part), function as a server (e.g., signaling server; server that manages part communication, component resources, tasks, other resources; etc.), route communications to other part services, and/or perform other functionalities. For example, the part process 220 can interface between the respective part and the master part. In this example, the part process can route external communications (e.g., requests, responses) to the respective resource, route part-generated communications (e.g., requests, responses) to the respective external endpoint (e.g., other part process, client, cloud platform, etc.), and/or perform other functionalities. Additionally or alternatively, the part processing systems can host or otherwise run a server (e.g., a communications server, such as a request-response server, a gRPC server, a WebRTC server, etc.; a server that manages part communication, component resources, tasks, other resources, etc.).

The part process 220 can additionally or alternatively: run the system-standard SDK that is used to interpret commands in the system-standard interface (e.g., run functions from the device development kit (RDK) or library); provide the messaging protocol interfaces (e.g., gRPC interface, WebRTC interface, WebSocket interface, HTTP interface, protobuf files, etc.); establish the communication connections (e.g., gRPC connection, WebRTC connection, WebSocket connection, etc.); authenticate, validate, sign, encrypt, and/or otherwise secure or verify the security or identity of messages and data; execute the hardware drivers; execute higher-level logic (e.g., analyze task outputs and/or component outputs; execute models; route messages or packages; etc.); connect to another device or part (e.g., while operating as a client); parse and respond to commands from a client (e.g., while operating as a server); parse and respond to changes in the device's configuration file; initialize the resources from the configuration file; and/or perform any other suitable functionality. In an example, the part process can include an instance of the server (e.g., viam-server) and/or client, include one or more SDKs, include one or more RDKs, and/or include any other suitable service, or include a subset thereof (e.g., only the server and RDK, only the server and SDK, etc.). The part process can function as a server and/or as a client (e.g., in the request-response architecture). For example, the part process can host a gRPC server implementing the system-standard API (e.g., Viam device API). The part process preferably tracks part state (e.g., the component state, the task state, a history of interactions with the part process, etc.), but can alternatively be stateless.

Each part 200 can include one or more part processes 220. Each device can include a single part process, multiple part processes (e.g., for each part of the device), and/or any other suitable number of part processes. In an example, the device can include a single part process on the main part, wherein the main part is connected to other parts of the device and registers the other parts as resources. The part process is preferably identified by an address (e.g., the processing system's address, another address), but can be identified using any other identifier.

The resources 240 function to perform an action in the physical or virtual space. Examples of actions include: sampling the physical world, acting upon the physical world, transforming data (e.g., performing analyses), and/or any other action. Each part can include one or more resources. Each resource can be associated with (e.g., directly communicate with) one or more part processes (e.g., from the same or different virtual part), one or more other resources (e.g., from the same or different virtual part), and/or any other set of part elements. The resource association with the part process can be specified by the configuration file, by physical connection to the same processing system, by execution on the same processing system, and/or otherwise specified. Each resource can be identified by an address (e.g., the component's address, the task's address, another address), a semantic identifier (e.g., manually assigned, automatically assigned, etc.), version identifier (e.g., timestamp, version index number, etc.), or any other identifier. Each resource can be a computing process or be otherwise implemented. Each resource can function as a server and/or as a client (e.g., in the request-response architecture). Each resource preferably tracks its own state (e.g., the component state, the task state, a history of interactions with the part process, etc.), but can alternatively be stateless.

The resources 240 can be provided (e.g., authored) by: the platform, one or more users (e.g., resource developers, etc.), manufacturers, and/or other entities. The resources 240 used by a part can be obtained from a component registry, resource store (e.g., “application store”), a default library or repository, and/or from any other suitable source. For example, the SLAM module for a part can be authored by a first developer, the component drivers for the components of the part can be authored by the component OEMs, the gRPC interface can be authored by a second developer, and the motion library for the part can be authored by a third developer. The resources 240 can be paid or unpaid. The resources 240 can be public or private (e.g., have restricted access to a predetermined set of users or devices). The resources can optionally be signed by the platform or other trusted entity that verified the resource, be unverified, or otherwise secured. The resources 240 in the shared repository can optionally be associated with metadata, such as the resource creation date, author identifier, number of devices using the resource, information about how to configure the resource, and/or other information.

Resources 240 can include component resources 244, tasks 242, and/or other resources.

Tasks 242 (“Viam services”) function to abstract away hard problems in devices. Tasks 242 can perform a set of computations (e.g., responsive to task calls), interact with other resources (e.g., component resources, other tasks, etc.), and/or perform other functionalities. Tasks 242 can be: algorithms, models (e.g., trained machine learning models, statistical models, etc.), and/or any other suitable logic or computation. Tasks 242 can be predefined and accessible to all devices, custom-defined (e.g., specific to a user account), and/or otherwise defined. Examples of tasks include: remote control, data management, frame management (e.g., conversion between reference frames, using calibration matrices), object detection, motion planning, navigation planning, slip detection, spatial math, point cloud analysis, vision algorithms (e.g., keypoint detection, object detection, object segmentation, Delaunay triangulation), calibration, execute machine learning models (e.g., perform inference or prediction; trained onboard or remotely; etc.), device modules (e.g., device monitoring, management APIs, etc.), frame systems (e.g., to hold the reference frame information for the relative position of components in space), SLAM (e.g., simultaneous localization and mapping), teleoperation, and/or any other suitable task. Examples of machine learning models that can be used include: classical approaches (e.g., linear regression, logistic regression, decision tree, SVM, nearest neighbor, PCA, SVC, LDA, LSA, t-SNE, naïve bayes, k-means clustering, clustering, association rules, dimensionality reduction, etc.), neural networks (e.g., CNN, CAN, LS™, RNN, autoencoders, deep learning models, etc.), ensemble methods, rules, heuristics, equations (e.g., weighted equations, etc.), selection (e.g., from a library), regularization methods (e.g., ridge regression), Bayesian methods (e.g., Naïve Bayes, Markov), kernel methods, probability, deterministics, genetic programs, and/or any other suitable model. The models can be trained using supervised learning, reinforcement learning, unsupervised learning, and/or otherwise trained.

A task 242 preferably accepts a call addressed to it, executes the task logic associated with the call, and returns the result of the execution (examples shown in FIG. 4 and FIG. 5). However, the task can be otherwise configured.

Tasks 242 can be associated with a set of component classes, or be unassociated with component classes. For example, object detection can be associated with (e.g., reference the image stream from) a camera class. When the task is associated with the set of component classes, the task logic can include a series of calls to the component class to retrieve information from and/or provide instructions to a connected component of said class. However, the task can be otherwise integrated with the component classes.

Component resources 244 (e.g., actuator modules, part resources, component services, etc.) function to represent a physical component and functions as the interface for the component (e.g., virtual component, physical component) with the rest of the system (e.g., to enable the rest of the system to interact with the component).

Each instance of a component resource 244 can represent a single physical component or multiple physical components (e.g., within the same device, within the same part, etc.). Each physical component is preferably associated with a single component resource instance, but can alternatively be associated with multiple component resources. In a first illustrative example, a single Arm service (e.g., for robotic arms) can support multiple arms within the device. In a second illustrative example, each arm is associated with its own Arm service.

The component resource 244 can be associated with a physical component 260 when: the physical component is connected to the processing system executing the component resource, based on the device's configuration file (e.g., the configuration file specifies the relationship, such as by associating a physical component identifier with the component resource, etc.), the component resource and the physical component are associated with a shared component class, and/or otherwise determined. The component resource-physical component association can be automatically determined, manually determined, set by default, determined by the component manufacturer, and/or otherwise determined. The component resource can execute on a processing system that is physically connected to the managed physical component, or execute on a physically separated processing system. However, the component resource can be otherwise associated with a physical component.

The component resource 244 can be associated with one or more tasks 242, or be unassociated with any tasks 242. The component resource 244 can be associated with a set of tasks 242: when the tasks and component resources are executed on the same processing system or process, when the tasks and component resources are associated with a shared part process, when the task-component resource relationship is specified by the device configuration, when the task references (e.g., calls) the component resource, when the device configuration specifies a relationship between the task and the physical component managed by the component resource, and/or otherwise associated.

In some situations, the physical component 260 can include a set of physical sub-components. For example, a gantry can include a motor and an encoder. When the physical component represented by the component resource includes sub-components, the component resource can additionally include child component resources, where the child component resources can represent the sub-components. Alternatively, the physical component can be represented by a single component resource that represents and interacts with (e.g., interfaces with) the set of physical components.

The system can include a different component resource 244 for each component class, a different component resource for each component model, a single component resource (e.g., for multiple component classes), and/or any other number of component resources. Different component resources preferably provide a different set of standard calls, but can alternatively be responsive to the same standard calls (e.g., include functions with the same reserved name). For example, an Arm component can include a GoToPosition( ) call, while a GPS component would not.

A component resource 244 preferably receives a call addressed to the respective physical component, and executes the logic associated with the call (examples shown in FIG. 4 and FIG. 5). Examples of the logic that can be executed includes controlling the associated physical component (e.g., actuating the component, controlling the component to sample measurements, etc.), obtaining information from the associated physical component (e.g., reading measurements off the component, obtaining the component state, etc.), executing component-related logic (e.g., a for loop, if-else logic, etc.), but other logic can additionally or alternatively be executed. Examples of executing the logic can include: sampling measurements, generating low-level component instructions to execute a goal associated with the call, and/or otherwise executing the logic. For example, an Arm component receiving a GoToPosition (specified_joint_position) call would generate and execute component instructions to move the arm to the specified joint positions. Each component resource can include or interact with one or more component drivers for the associated component.

In variants, each component resource 244 can convert or translate system-standard calls (e.g., system-standard API calls, platform-standard calls, etc.) to component-specific calls (e.g., to execute the logic). Examples of component-specific calls (e.g., actuator instructions, etc.) include: driver calls for the component's driver, component-native calls (e.g., in the component's native protocol), machine-level commands, and/or any other suitable command or instruction. The component resource 244 can perform this conversion by: being specifically configured to perform the conversion (e.g., be hardcoded to generate the component-specific call), using a library for the specific driver or component model (e.g., wherein the library defines the system-standard call—to—component-specific call mapping), and/or otherwise performed. When libraries are used, the libraries can optionally be signed by a trusted entity, such as a platform administrator or other trusted entity. In an example, the same system-standard call can be translated into different component-specific calls for different components (e.g., different component types, different component make/models, different component instances, etc.). The component resource 244, component 260, part process 220, and/or other process can verify the signature before using the library. Each component resource 244 is preferably specific to a component class (e.g., component type), but can alternatively be shared across component classes. Each component resource 244 can be specific to a component model (e.g., only configured to map system-standard calls to that component model's driver calls), or shared across different component models (e.g., configured to map the system standard-calls to the corresponding driver calls for each of a plurality of component models).

In an example, the component resource 244 can: determine the system-standard call, extract the variable values from the system-standard call, identify the driver call template (e.g., for the component model's driver) corresponding to the system-standard call, generate a driver call (or component-native instruction) using the extracted variable values (e.g., directly using the extracted variable values, optionally converting the extracted variable values to another data type or reference frame, etc.), and send the driver call (or component-native instruction) to the component's driver for execution. However, the component-specific call can be otherwise determined. In an illustrative example, arm.movetoposition(x1,y1,z1) can map to a first driver call for a first arm model and map to a second driver call for a second arm model, wherein both driver calls move the respective arm components to the x1,y1,z1 position. However, the system-standard call can be otherwise converted to the component-specific call.

The component resource 244 can optionally interpret component outputs into system-standard outputs (e.g., system-standard responses). The component resource can: convert the component-specific output type to the system-standard response type (e.g., generate a system-standard acknowledgement based on component-specific message receipt signal), convert the component-specific output format to the system-standard response format (e.g., ontology, message format, etc.), convert the component-specific output object type to the system-standard response object type (e.g., string to integer, etc.), convert the component-specific output values to the system-standard response values (e.g., by applying corrections, calibrations, etc.), and/or otherwise converting the component-specific output to a system-standard response. The component resource can be hardcoded to perform the conversion, perform the conversion using a set of libraries (e.g., using the library for the respective component model, used to generate the component-specific call), and/or otherwise perform the conversion.

However, the component resource 244 can be otherwise configured.

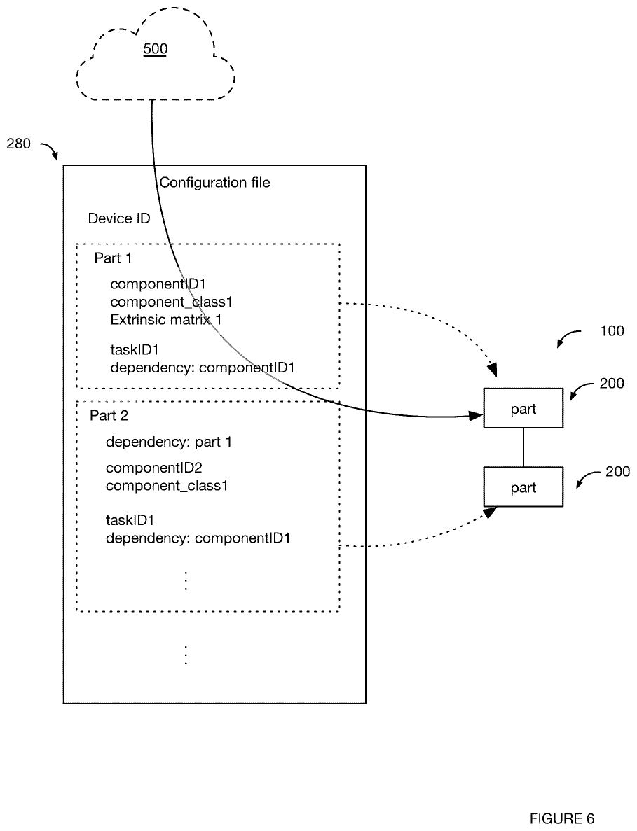

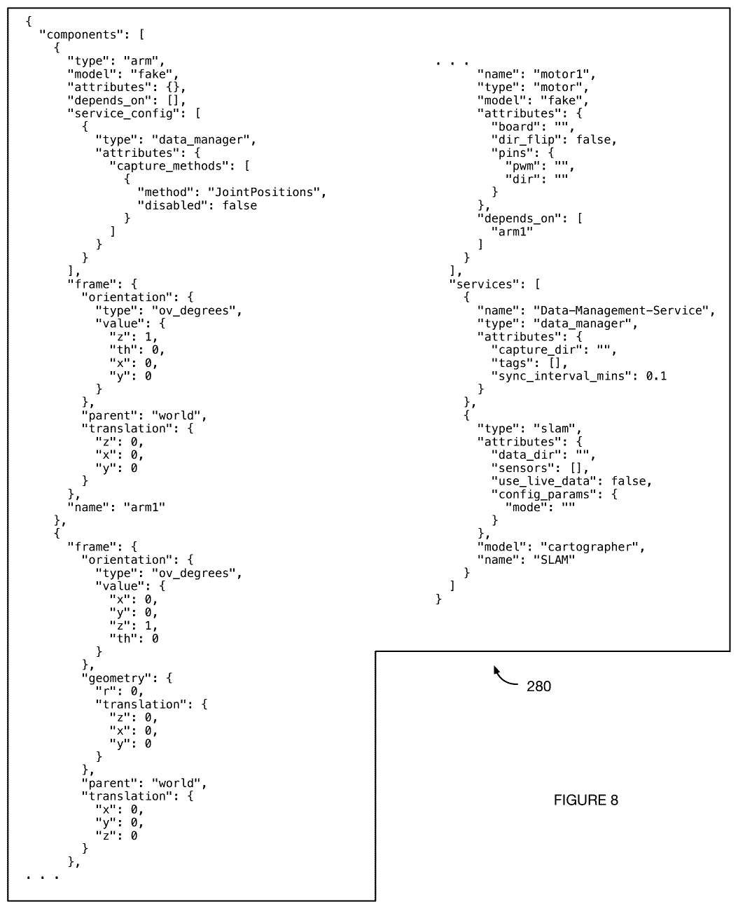

The system can also include one or more device configurations 280 (configuration files), which functions to define the device parts, element relationships, inter-device relationships, and/or any other suitable device parameter for a device (e.g., examples shown in FIG. 6 and FIG. 8). The device configuration 280 can also include initialization information (e.g., initialization values, file paths, etc.), operation information (e.g., where to write artifacts to, where to pull external information from), update information (e.g., where to pull updates from), shutdown information (e.g., the shutdown process), and/or any other suitable information. The device configurations 280 can be associated with a device identifier or otherwise associated with the device. The device configuration can be or include: a configuration for a device (e.g., set of device parts), a single device part, a part process, a resource (e.g., task resource, component resource, etc.), and/or for any other suitable device element.

The device part definition can include: a part identifier (e.g., semantic identifier), part dependencies, part logic (e.g., for execution by the part process), resource parameters, remote endpoints (e.g., fleet management endpoint, client endpoints, peer identifiers, addresses, URIs, etc.); and/or other part information.

Resource parameters can include: the component class, the component model, the component identifier (e.g., semantic identifier), reference frames (e.g., extrinsic calibration matrices relative to a global reference frame), intrinsics, component values (e.g., sampling rate, actuation rate, etc.), the task class, the task identifier (e.g., semantic identifier), task values (e.g., variable values, initialization values, etc.), remote endpoints (e.g., library endpoint, etc.), and/or any other suitable resource parameter. In an example, the device part definition can include a set of device part instances.

Element relationships can include: inter-part relationships, part-resource relationships, inter-resource relationships, and/or any other relationship between different device elements.

Inter-part relationships can include: part dependencies, calibration matrices, connection endpoints (e.g., peer addresses, etc.), connection logic (e.g., which conditions trigger connection initiation), connection parameters (e.g., which transport layer or communication protocol to use, timeout values, etc.), communication logic (e.g., which conditions trigger communications between parts, which conditions trigger request generation and transmission, etc.), and/or any other part relationship. For example, the inter-part relationships can specify the parent parts, child parts, grandparent parts, grandchildren parts, sister parts, extrinsics calibration matrices between the part and another part (e.g., parent part, child part, sister part, etc.), temporal calibrations between the part and another part, and/or other information.

Part-resource relationships can include: part-resource dependencies (e.g., which resources are associated with which part), and/or other relationships. For example, the part-resource relationships can specify the component resources for the part, the task resources for the part, and/or any other suitable information.

Inter-resource relationships can include: task-component dependencies (e.g., which components are referenced by each task, which task references each component), component resource dependencies, and/or any other suitable inter-resource relationship. Component resource dependencies can include: which component resources are associated with which physical components, the component resource dependencies with other component resources (e.g., parent component resources, child component resources, etc.), the task resource dependencies with other tasks, the task resource dependencies with the component resources (e.g., which tasks provide inputs to the component resource, which tasks ingest the component resource output), and/or other resource dependencies.

Inter-device relationships can specify which other devices to connect to, when, how, and/or other inter-device relationship parameters. For example, the inter-device relationships can include: a fleet identifier, peer device identifiers (e.g., addresses, URIs, semantic identifiers, etc.), device dependencies (e.g., child relationships, parent relationships, etc.), connection logic (e.g., which conditions trigger connection initiation), connection parameters (e.g., which transport layer or communication protocol to use, timeout values, etc.), communication logic (e.g., which conditions trigger communications between devices, which conditions trigger request generation and transmission, etc.), and/or other information.

The device configuration 280 can optionally include security information (e.g., security keys, API keys, etc.), connection information (e.g., which protocol to use, which transport layer to use, what information to use to connect to the ego device, what information to use to connect to another device, what information to use to connect to a remote computing system, etc.), and/or any other information. This information can be specified at the device level, at the device part level, at the resource level, and/or at any other suitable level. When the information is specified at a higher hierarchical level, the child elements can inherit the information (e.g., all device parts inherit the security information and connection information for the overarching device; all devices inherit the security information and connection information for the overarching fleet; etc.); alternatively, the child elements can not inherit the information, wherein a master element (e.g., the master part) uses said information.

The device configuration 280 can optionally include or be used with control logic (e.g., program 500), which functions to control device operation (e.g., example shown in FIG. 12). The control logic can be included within the device configuration or be a separate file. The control logic can reference device parts, resources within each part (e.g., component resource calls, task resource calls, etc.), and/or any other suitable device element. The control logic can be executed by the main part, each individual part, a remote computing system, and/or by any other suitable system.

However, the device configuration 280 can include any other suitable information for device initialization, operation, and/or shutdown.

Each device 100 can be associated with one or more device configurations 280. In a first example, the device is associated with a series of device configurations (e.g., different configuration versions), which are used at different times. In a second example, the device is associated with a set of configurations, wherein each configuration can be associated with a different device part, part process, resource, and/or other element of the device. Different devices within the same fleet can have the same or different device configurations. Different parts within the same device can have the same or different device configurations. Different elements of the device part can have the same or different device configurations (e.g., two instances of the same task on the same part can have the same or different configuration). However, the device can be associated with any other suitable number of configurations, related in any other suitable manner.

The device configurations 280 can be defined on a remote computing system (e.g., in a GUI, in a UI, in a programmatic manner, etc.), but can additionally or alternatively be defined on the device, or defined elsewhere. The device configuration is preferably manually defined (e.g., by a user), but can alternatively be automatically defined (e.g., based on physical connections), be learned, be set by default, and/or otherwise defined. For example, all device parts with a physical LiDAR can have a LiDAR component resource and a SLAM task by default.

The device configurations 280 can be stored: by the remote computing system (e.g., the cloud), locally on the device (e.g., by the main part, by all parts, by a subset of the parts), and/or otherwise stored. In an example, the device configurations for all devices can be stored on the remote computing system, wherein each device retrieves its own device configuration (e.g., using a shared secret used to authenticate and/or identify the device with the remote computing system) (e.g., example shown in FIG. 6). The device and/or each device part can: locally store the retrieved device configuration for a predetermined period of time (e.g., 30 days, 60 days, etc.); query the remote computing system for new or updated device configurations at a predetermined frequency (e.g., 15 seconds); and/or otherwise manage or obtain the device configuration. In an illustrative example, the device (and/or the device part) can use a request to retrieve the response configuration from the remote computing system (e.g., configuration repository). This can be done based on locally-evaluated logic (e.g., a timer has expired, the current device configuration is invalid, etc.), based on a request received from the remote computing system (e.g., instructing the device and/or the device part to retrieve the device configuration), and/or performed at any other time.

Each device wo and/or device part 200 preferably parses and initializes the virtual elements (e.g., initializes processes and loads the identified packages) according to the device configuration and/or operates using the device configuration, but can use the device configuration in any other manner. For example, the device and/or device part can download the update package, optionally verify the signature on the package, extract the binary or configuration from the package, and execute the binary or reconfigure the device based on the configuration.

The system can leverage one or more message passing architectures (e.g., communication architectures, communication frameworks, communication protocols, transport layers, etc.) to pass messages. The messages can be passed between (e.g., the communication channels can be established between): devices, device parts, part processes, components (e.g., physical components), resources (e.g., tasks, component resources, etc.), remote endpoints (e.g., cloud, mobile, etc.), and/or any other suitable combination of any other suitable endpoints. The system can use a heterogeneous architecture (e.g., using multiple different types of communication protocols and/or transport layers) and/or use a homogeneous architecture (e.g., all elements conform to the same communication protocol). However, any other set of device elements can conform to the message passing architecture.

The message-passing architecture is preferably a service-oriented architecture (e.g., leveraging a response-request paradigm), but can additionally or alternatively be an event-driven architecture (e.g., leveraging a subscribe and parallel processing paradigm or publication-subscription paradigm), and/or be any other architecture. In a first example, the message-passing architecture is not a publication-subscription architecture (e.g., the system does not use a pub-sub architecture for any communications between any device parts, devices, remote computing systems, or other components). In a second example, the message-passing architecture only includes a request-response architecture (e.g., all communications between parts, devices, remote computing systems, and/or other components use only response-request architectures). In a third example, the message-passing architecture can use a request-response architecture for all or a subset of the communications (e.g., between the remote computing system and the device or main part; between the main part and the child parts; etc.), wherein the remainder of communications can use a pub-sub architecture or other architecture. However, any other suitable message-passing architecture or combination thereof can be used.

The system can leverage one or more protocols configured to implement the message passing architecture. The protocols are preferably standard web protocols, but can alternatively be any other protocol. Examples of protocols that can be used include: remote procedure call systems (RPC system), such as gRPC, SOAP, JSON-RPC, and/or other RPC systems; WebRTC; other real time communications systems; WebSockets; a HTTP protocol (e.g., HTTP2, HTTP3, etc.); a REST system; and/or any other suitable protocol. Additionally or alternatively, the protocol can be determined by the physical interface (e.g., connector), such as USB, Ethernet, MIPI, media transfer protocol, GMSL, coaxial, and/or any other suitable protocol. Communication between different system elements can use different protocols (example shown in FIG. 3). For example, remote part communication (e.g., with the remote computing system) can use gRPC, while local communication between parts can use gRPC or webRTC. In this example, local communication between the part process and the components (e.g., the physical components) can be over any protocol supported by the component or the physical interface, wherein the messages can be converted the component-supported protocol using the component driver (e.g., executed by the component resource, executed by the part process, etc.). However, any other suitable set of protocols can be used for inter-element communication. In operation, clients can request information from a service (e.g., device, part, component, task, resource, etc.) on an as-needed basis (e.g., using gRPC), open a persistent communication channel to stream data from the service to the client (e.g., using WebRTC), or otherwise communicate with the service. The service preferably does not publish data without a prior request, but can alternatively publish data to a broker and/or any other suitable recipient.

The system can leverage one or more communication channels 400, established between different system elements. The communication channels 400 are preferably persistent, but can alternatively be temporary. The communication channels 400 are preferably stateful, but can alternatively be stateless. The communication channels 400 can be established using the communication protocol (e.g., WebRTC, gRPC, HTTP2, etc.), but can be established using the physical interface or otherwise established. Communication channels 400 can be established: between each device and the remote computing system; between devices; between parts (e.g., within the same device, across devices); between components (e.g., between component resources of the same or different part or device); between tasks (e.g., of the same or different part or device); between components and tasks; and/or between any other set of device elements. Communication channels of different types (e.g., using different network protocols, having different characteristics, etc.) can be used by different system element pairings. For example, inter-device communication can be over HTTP2, while device-remote computing system communication can use a different protocol.

In a first example, two or more devices are connected using a response-request protocol. In a second example, two or more device parts (e.g., on the same or different devices) are connected using a response-request protocol. In a third example, a device process can be connected to a component resource and/or a task resource using a response-request protocol. In a fourth example, a component resource, device process, device part, and/or device can be connected to a remote service, such as a cloud service, mobile service, browser, or other endpoint, using a response-request protocol.

In a first illustrative example, a device can include a set of device parts, wherein each device part is connected to at least one other device part using a first response-request protocol, the device processes are connected to the respective resources using a second response-request protocol, and the device processes, resources, and/or device parts are connected to a remote service using a third response-request protocol (e.g., the same as or different from the first or second response-request protocol).

In a second illustrative example, a device can include a set of device parts, wherein each device part is connected to at least one other device part using a heterogeneous set of response-request protocols; the device processes are connected to the respective resources using the same response-request protocol; the component resources (e.g., executing on a part processor) are connected to the physical components using the protocol of the physical interface (e.g., connecting the physical component to the part processor); and the device processes, resources, and/or device parts are connected to a remote service using a heterogeneous set of response-request protocols (e.g., the same as or different from the first set of heterogeneous protocols).

However, any other suitable set of protocols can be used to connect any other suitable set of system elements.

The data sent using the communication protocol, via the connections 400, can include: requests (e.g., resource calls, etc.), responses (e.g., acknowledgments, requested data, etc.), measurements, states (e.g., component state, resource state, part state, device state, logs, etc.), artifacts (e.g., generated during operation), and/or any other suitable data. Examples of measurements can include: audio data, video data, kinematic data (e.g., accelerometer data, odometry data, gyroscopic data, etc.), encoder data, temperature, pressure, humidity, position data (e.g., measured by a GPS, trilateration system, etc.), depth data (e.g., measured using a depth sensor, such as LiDAR, stereo camera, etc.), and/or any other suitable measurement. In a specific example, the transmitted data can exclude audio-video data (e.g., be non-audio-visual data). In a second specific example, the transmitted data can include audio-video data. However, any other suitable data can be transmitted using the communication protocol and/or connection 400.

The system can provide and/or use a system-standard interface (e.g., a device development kit application programming interface; RDK API; browser interface; etc.). The system-standard interface can provide a set of predefined methods accessible using a set of reserved names. As discussed above, the system-standard interface can provide a different set of standard methods for each component class and task class, wherein each resource instance can respond in the same way to the same standard method call, regardless of hardware (e.g., regardless of the component model). Each method can include a series of resource calls, transformations, and/or other logic to implement the goal associated with the method. For example, a “GetObjectPointClouds(cameraID)” call to an Object Segmentation task will: look up the identified camera, obtain a point cloud from the camera resource (e.g., by calling a “GetObjectPointCloud( )” method on the camera resource), use a point cloud segmentation algorithm to segment geometries in the returned point cloud, and return the geometry segments and bounding geometries. However, the system can support any other suitable interface language.

The system can be used with one or more remote computing systems (e.g., platforms 300). A remote computing system (e.g., platform 300) can: manage one or more device sets (e.g., define or store device configurations for each device in each set, control configuration provisioning, etc.); manage one or more user accounts associated with the device sets (e.g., control account permissions, etc.); provide security for the devices (e.g., provision security credentials, authenticate device requests, decrypt device communications, etc.); store data from devices (e.g., data streams, etc.); remotely control a device or device part (e.g., send resource calls, process resource responses, etc.); and/or perform other functionalities. The remote computing system can be: a cloud server, a local hub, a device, a user device (e.g., a laptop, a smartphone, a browser, a native application, etc.) and/or any other computing system. The remote computing system can function as a client or as a server. In examples, the remote computing system can function as a signaling server; register device elements (e.g., device parts, component resources, task resources, etc.); facilitate inter-element connections (e.g., by providing the part addresses, resource addresses, etc.); and/or provide any other suitable functionality. The remote computing system can be persistently connected to one or more devices, periodically or intermittently connected to the devices, and/or otherwise connected to the devices.

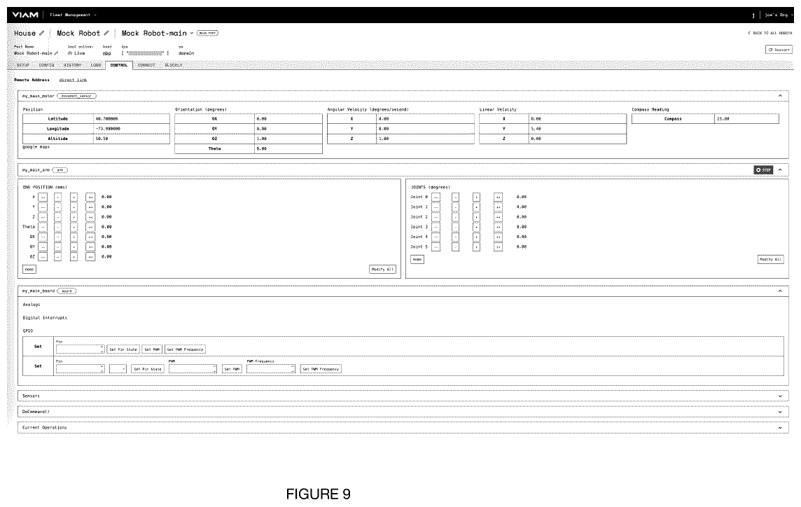

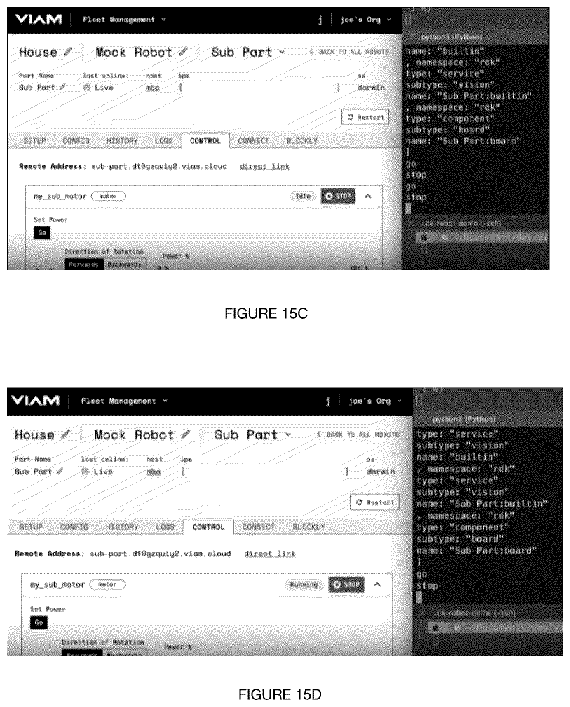

The system can additionally or alternatively provide a user interface, which can be used to interact with the devices. Device interaction can include: specifying the device configuration (e.g., example shown in FIG. 9); remotely controlling the device (e.g., using a WebRTC connection established between the user interface and the device; example shown in FIGS. 15A-15D); receiving data from the device (e.g., using the connection established between the user interface and the device and/or elements thereof; example shown in FIGS. 15C and 15D); and/or otherwise interacting with the device. The user interface can be: a GUI, a programmatic interface (e.g., a CLI tool, a browser-based tool, a browser interface, a web interface, a mobile interface, a smartphone application, etc.), and/or any other interface. The user interface can leverage a system-standard SDK to communicate with the devices, and/or leverage any other suitable protocol. In variants, the system can include multiple system-standard SDKs, wherein different SDKs are specific to different programming languages (e.g., Python, Rust, Java, C, C++, etc.). The SDKs can convert commands received in the programming language to system-standard commands (e.g., provide a mapping between commands; etc.); and/or provide other functionalities.

However, the system can include any other set of elements.

4. Method.

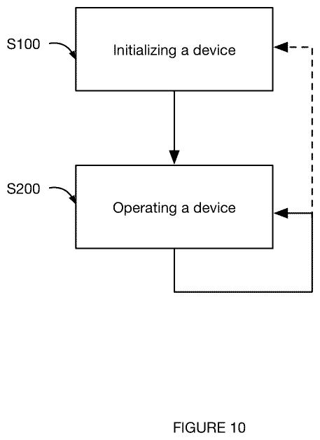

As shown in FIG. 10, variants of the method for operating a device can include: initializing a device S100; operating a device S200; and/or otherwise using the device. The method can be performed for every device or a subset of devices. all or a portion of the method can be performed for each device: periodically, intermittently (e.g., responsive to occurrence of an event), iteratively, based on a program 500, and/or at any other time.

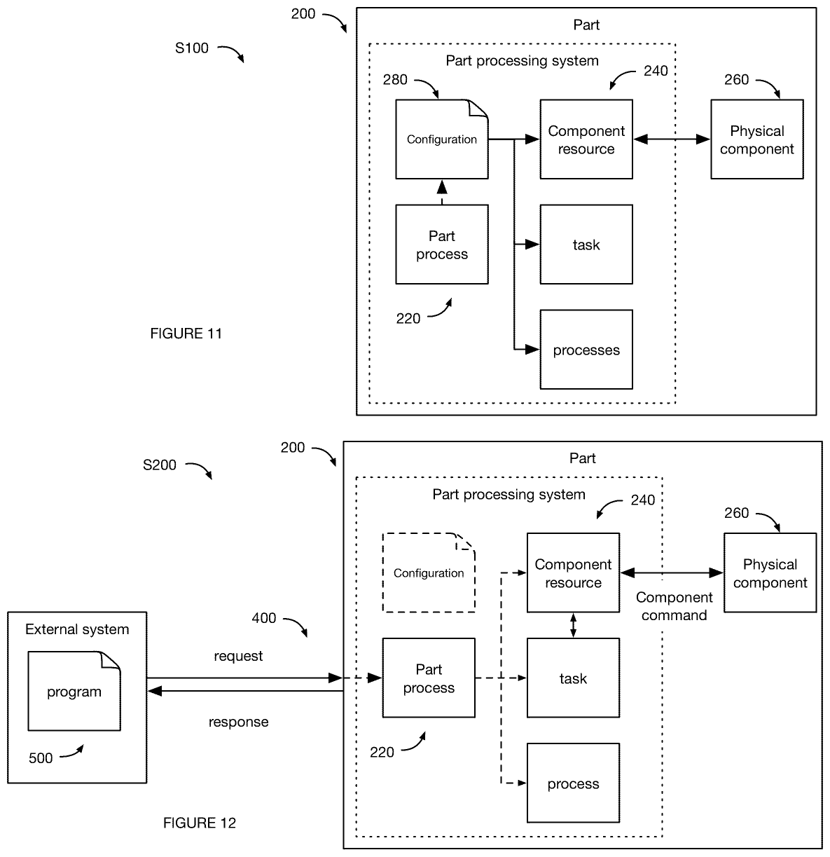

Initializing the device S100 functions to initialize the virtual representations of the device elements and optionally establish the relationships between the device elements. Initializing the device can include: installing a part process on at least one part of the device; obtaining the configuration file for the device; initializing the device elements according to the configuration file (e.g., examples shown in FIG. 6 and FIG. 11); establishing connections between device elements, and/or other processes.

The part process can be installed by the part manufacturer, be installed by the user, and/or be otherwise installed. In an example, a user device can SSH into the part and control the part to download the part process. The part can also register itself with the user device by providing the part's identifier (e.g., address, key, etc.) over the SSH connection.

Obtaining the configuration file functions to obtain a description of which virtual device elements to initialize. This is preferably performed by the device, but can alternatively be performed by a user, by the remote computing system, and/or by any other system. This can be performed: periodically (e.g., at a predetermined frequency), responsive to occurrence of an event (e.g., certificate expiration), when a user pushes the configuration to the device, when a user provisions the device, and/or at any other time. In a first variant, the configuration file is retrieved from the remote computing system. The configuration file can be obtained using shared secret stored onboard the device (e.g., used to sign the configuration file request, used to encrypt the configuration file request, etc.), using a device identifier, and/or obtained using any other data. The configuration file can be obtained via a connection established between the device (e.g., main part, individual parts, etc.) and the remote computing system (e.g., via gRPC, via gRPC via WebRTC, etc.). In a second variant, the configuration file is retrieved from local storage, and can be encrypted, otherwise protected (e.g., only used when the configuration file hash matches a target hash), or unprotected. In a third variant, the configuration file is sent by an external device (e.g., user device) remotely controlling device element operation (e.g., via SSH).

The configuration file can be received from a user (e.g., from a browser, from a file, from an interface, etc.), be a predetermined configuration file, and/or be otherwise determined. Different configuration files can be generated for different devices, device parts, device resources, and/or other device elements (e.g., in the same fleet). In an illustrative example, a user can set up a device on an interface by specifying the name of each device part, the type of said device part, the model of the device part, the attributes of the device part (e.g., the required attributes), the data capture type and parameters (e.g., data capture frequency, directory, etc.), the coordinate frame (e.g., parent part, translation, orientation, geometry type, such as box or square, etc.), part dependencies, resources that are being used, each resources' attributes, modules, and/or other data.

Initializing the device elements functions to create the virtual element instances that can subsequently generate and/or respond to commands. This can include: initializing computing processes for elements identified in the configuration; establishing connections between connected elements; and/or otherwise initializing the device elements.

The computing processes are preferably initialized on the processing system for each respective part, but can alternatively be initialized on the main processing system (e.g., of the main part), be initialized on the components of each respective part, be initialized on a remote computing system, or be initialized on any other hardware. The computing processes can be initialized using the packages for each element identified in the configuration (e.g., wherein the packages are loaded for each process), the drivers for each component, and/or using any other data. In a first variant, a single computing process (e.g., service) is created for each unique component class within the configuration. For example, when a device includes multiple arms, a single arm service can be initialized for all arms. In a second variant, a different computing process is initialized for each component class instance in the configuration. For example, when a device includes multiple arms, multiple arm services are initialized, one for each arm. However, any other suitable number of processes can be initialized for any other suitable number of components.

Initializing the computing processes can additionally or alternatively include establishing the dependencies between different processes (e.g., generating a tree representative of the process dependencies) and optionally registering the processes.

The dependencies are preferably specified by the configuration file, but can be automatically determined, or otherwise determined. For example, a parent part can be the part with the most parts directly connected to it. In another example, the parent parts are randomly determined.

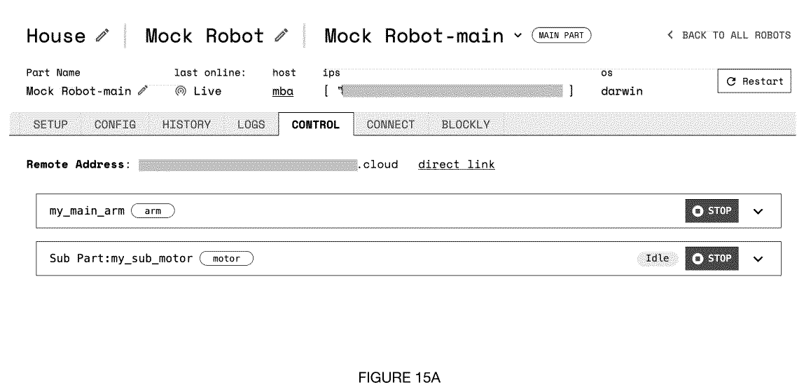

The device elements can be automatically registered (e.g., using its configuration), manually registered (e.g., wherein a user device connects to the device element and requests the device element identifier), and/or otherwise registered. The device elements can be registered by a central registry (e.g., the platform, a registry specified by the configuration, a master part, etc.), by a physically-connected device element, register itself with the respective part process, register itself with another part that the device element is connected to, register itself with a parent element (e.g., parent process), and/or register with any other suitable entity (e.g., examples shown in FIG. 13). The device elements can be registered using a connection established using the operation communication protocol (e.g., the connection protocol used to stream data to an endpoint), using a communication protocol different from the operation protocol, using a connection established by the physical connection, using a local wireless connection (e.g., wherein an external device initializing the device element searches for the device element, such as using Bluetooth); and/or using any other suitable connection. In a first example, the part process of the device part can automatically register itself with a central registry (e.g., the platform) upon power-up. In a second example, the part identifier is determined by a user (e.g., during part setup, etc.). However, the device part can otherwise register itself with the registry. The registered information for each device element (e.g., identifier, address, resource class, etc.) can be stored locally, stored in by the remote computing system, stored by the registry, and/or otherwise stored, or not stored.

Establishing connections functions to establish communication connections between different processes. Connections are preferably established between: dependent processes, processes identified as requiring connections in the configuration file, devices, parts, resources, and/or any other set of processes. The connections can be established: locally, remotely (e.g., via the remote computing system), and/or otherwise established. The connections can be established using a wired connection (e.g., USB, Ethernet, etc.), a wireless connection (e.g., Bluetooth, NFC, WiFi, cellular, Internet, etc.), and/or any other suitable connection. The connection can be established using a local area network, a wide area network, and/or any other suitable network. The connections can be peer-to-peer connections, client/server connections (e.g., wherein a process can play a specific role, a randomly-selected role, or both roles), and/or any other suitable type of connection. The identifier for the other process (e.g., peer, endpoint) that a process is connecting to can be determined from the registry (e.g., master part, central registry, etc.), from the configuration file, from another process, and/or otherwise determined. Connections can be established between: devices, parts (e.g., part processes), components (e.g., component resources), tasks, remote endpoints (e.g., servers, cloud services, mobile applications, browsers, etc.), and/or any combination thereof. For example, connections can be established between: a first and second part (e.g., part process), a first and second device (e.g., master parts of each device, part processes of the master parts, etc.), a first and second resource (e.g., between a task and a component, etc.), a part and a remote endpoint, a resource and a remote endpoint, a resource and another part (e.g., that the resource is not part of), and/or any other suitable combination of services.

In one variant, a part element (e.g., part, part process, resource, component, task, etc.) can establish a connection to a second process by: requesting a connection to the second process from a service (e.g., from the remote computing system, a signaling server, a master part, etc.), wherein the service returns the connection details (e.g., address, port, etc.) for the second process. The connection details can be predetermined and stored by the service, requested responsive to receipt of the connection request from the first process, and/or otherwise determined. The connection details are then sent to the first part, wherein the first part connects directly to the second part using the connection details (e.g., example shown in FIG. 14).

However, the connections can be otherwise established.

Operating the device S200 functions to control the device to interact with the physical world. Device operation can be controlled: locally (e.g., autonomously; using a script or higher-level control logic loaded onto the device); remotely (e.g., autonomously or by a user; teleoperated, etc.); by another device or device part; and/or by any other control system. Operating the device can include: receiving a request and responding to the command (examples shown in FIG. 4, FIG. 5, and FIG. 12); and can optionally include other processes.

Receiving a request functions to receive a command. The request is preferably received at the part (e.g., part process), but can additionally or alternatively be received at the component resource, task resource, other resource, remote endpoint, and/or any other suitable service. The request can be received from: a user (e.g., from a user device, a browser, a native application, etc.), the remote computing system, a local control system (e.g., the root part; the main process; etc., wherein the local control system generates the request or forwarded the request), another part, another device, another resource, and/or any other source. In variants, when the source is controlling multiple device parts, the source can run multiple servers (e.g., one for each part, one for each directly-connected part, etc.), or run a single server. The request is preferably compliant with the standard programming interface (e.g., follows the system-standard ontology and call structure), but can additionally or alternatively be noncompliant. The request can include: a command (e.g., method call), a part identifier, a resource identifier (e.g., component resource ID, task ID, etc.), argument values, and/or other data. The request can be encrypted (e.g., using a shared symmetric or asymmetric keypair), signed (e.g., with a security key), and/or otherwise protected or authenticated. Upon receipt, the part can validate the request (e.g., verify signatures, etc.), decrypt the request, send a response (e.g., a message acknowledgement, etc.), and/or perform any other processes based on request receipt.

The service can then parse the command, execute the command (e.g., using the argument values) in the request, and respond to the command. For example, the component resource, task resource, or part process identified in the request can execute the command based on the argument values. In a first illustrative example, an arm resource can move the arm to the specified joint location. In a second illustrative example, a camera resource can sample images at the requested exposure, zoom, and framerate, optionally establish a connection to a specified remote endpoint, and stream the resultant image stream to the specified remote endpoint. In a third illustrative example, a task resource executes the task using the component data identified in the request. The response can include: confirmation that the command was executed, the end state after executing the command, measurement streams, state streams, other data streams, and/or any other suitable information. The command responses can be processed by the client that sent it (e.g., using higher-level logic), wherein the client can generate a successive set of commands for one or more parts, based on the response.

In a first variant, the command is directed to the part process, and the part process generates the response.

In a second variant, the command is directed to a resource managed by the part process (e.g., connected to the part process), wherein the part process routes the command to the resource or calls the associated command on the resource. Alternatively, the command is directly sent to the resource (e.g., via a direct connection to the resource).

In a first embodiment, the command is directed to a task, wherein the task receives the command addressed to it, optionally looks up the component associated with the command or task (e.g., a child component, a component identified in the configuration file, the component sharing the same part, etc.), determines the requisite data (e.g., by sending a request to the associated component; by retrieving data stored by the task), processes the data using the task logic (e.g., using a trained machine learning model, using predefined logic, etc.), and returns the result. However, a task can otherwise respond to a command.

In a second embodiment, the command is directed to a component, wherein the component resource receives the command addressed to it; and controls the physical component to execute the command. The instructions sent to the physical component to execute the command can be: the command itself (e.g., when the API is pre-loaded onto the physical components); the command translated into another language supported by the physical component (e.g., using a mapping, using a driver, etc.); the command translated to a component-specific, low-level machine instruction (e.g., using a driver); and/or any other suitable instruction. Executing the command can include: returning information (e.g., a state, a measurement, etc.); acting on the physical world (e.g., actuating within the physical environment); and/or otherwise executing the command.

In a first example, the part element requests (e.g., part process calls, component calls, task calls, etc.) can be generated by a remote endpoint executing a set of logic. The remote endpoint can send the part element requests to the respective part element(s) over connections established with the respective part elements. The connections can be direct (e.g., wherein the remote endpoint is directly connected to the respective part element) or be indirect (e.g., wherein the remote endpoint is connected to an intermediary part element that is a remote of the target part element). The part element can then execute the command associated with the request, and respond to the remote endpoint accordingly.

In a second example, the part element requests (e.g., part process calls, component calls, task calls, etc.) can be generated by another part element executing a set of logic (e.g., the part process of another part of the same or different device, another resource on the same part, etc.). The originating part element can send the part element requests to the respective part element(s) over connections established with the respective part elements. The connections can be direct (e.g., wherein the remote endpoint is directly connected to the respective part element) or be indirect (e.g., wherein the originating part element is connected to an intermediary part element that is a remote of the target part element). The part element can then execute the command associated with the request, and respond to the remote endpoint accordingly. In a specific example, a part can iteratively receive new requests, generate new responses responsive to the new requests, and send the new responses using the request-response communication protocol.

However, the device can be otherwise operated.

In an illustrative example, a device can include a set of parts, each corresponding to a compute unit (and the components it controls). For example, a device can be organized into one or more parts, depending on the number of compute units it contains. Each part can run a session of the part process (e.g., platform server, “Viam server”), which receives API requests (e.g., a system-standard call) and translates the API requests to component operation (e.g., hardware actuation). The part platform can also read in and/or operate based on a configuration file that defines the components, services (e.g., resources), other processes for the part, and remotes (e.g., other parts of the devices that the part should communicate with, remote endpoints, etc.). Processes can include scripts or programs 500 run by the part process (e.g., Robot Development Kit (RDK)) whose life cycle is managed by the part process. Processes can be binaries or scripts that the part process will run either once or indefinitely and maintain for the lifetime of the part process. In a first example, a process can run an SDK server, like the Python SDK, where the implementation of a component is easier to create than the RDK. In a second example, a process can run a camera server that has the appropriate system driver to talk to the camera and communicate results over the wire.

In one example, a process can run a Software Development Kit (SDK) server, similar to the Python SDK, where the implementation of a component can be easier to create than in the RDK. A remote can represent a connection to another device part that is part of the same device, part of a different device, not part of a device at all (e.g., a user device, cloud system, etc.), and/or any other suitable external endpoint.

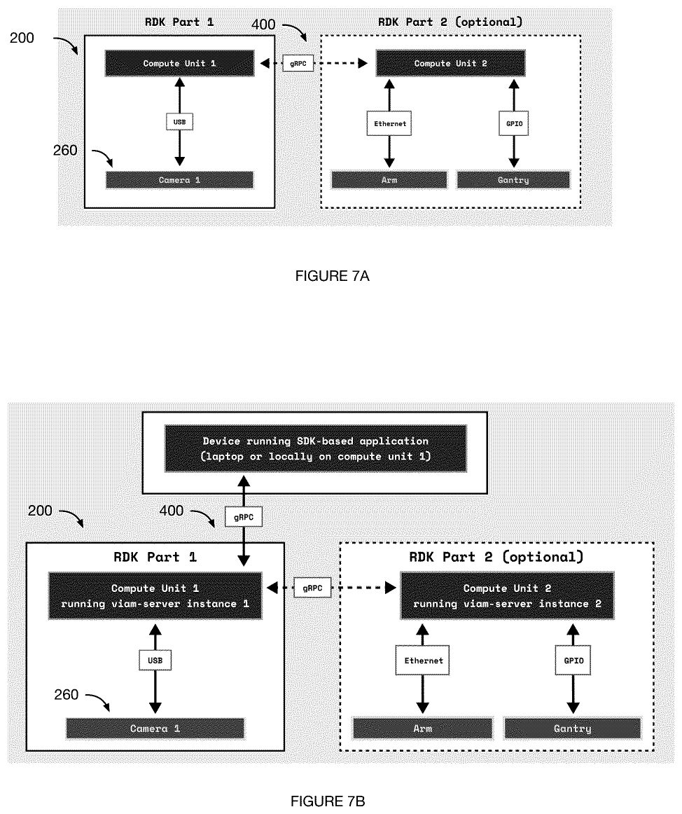

In a specific illustrative example, FIG. 7A depicts an example of a two-part device. Each part has its own compute unit which runs an instance of the part process (e.g., viam-server) and communicates with its respective components. Part 1 is the main part and could exist without Part 2. Part 2 is a remote.

The part can control the hardware based on libraries in an RDK (device development kit), wherein the part can translate the API calls into component-specific calls using said libraries. If the particular model of hardware (e.g., component model) that a user is working with is not supported in Viam's RDK, the user can write their own implementation of a component resource. If there is an existing library for the component type, a new component resource for the new component model can be written in just a few dozen lines of code (e.g., by updating default values to model-specific values, mapping driver calls to system-standard calls, etc.).

Parts can communicate with one another using a consistent and unified API, regardless of the hardware they are running on. This can be done via WebRTC using the gRPC and protobuf APIs, using gRPC, using Websockets, using HTTP protocols (e.g., HTTP2, HTTP3, etc.), and/or other response-request protocol (e.g., preferably an Internet-standard protocol, alternatively a device-standard protocol or custom protocol). This API can be available in any language, and can provide direct and secure connections and communications to and between parts.

After installing the part process (e.g., Viam server) on the compute unit of a part (e.g., RaspberryPi, microcontroller, etc.), a user can connect their newly minted part to the platform (e.g., the Viam App, via a URI such as https://app.viam.com, via an API endpoint, etc.). The platform can: provide an interface (e.g., web page) for each device to display part process logs, which can include status changes and error messages; provide a UI for building out the user's device configuration; provide an interface for testing the user's device components and services without needing to write any script (e.g., driving the motors and viewing camera feed; using a virtual device with virtual components; etc.); contains boilerplate connection code to connect parts to other parts; and/or perform any other functionality.

SDK-based applications can be run locally on one part of the device or on an entirely separate computer (e.g., a user device, a cloud computing system, etc.). The SDK-based applications can use the same APIs as the platform interface. FIG. 7B depicts an example architecture showing how SDK-based applications can communicate with the user's device's main instance of the part process (e.g., viam-server) over gRPC. The part can manage this process and will expose the API in the same way as with all other components. As a user creates more devices or starts collaborating, the user may wish to manage other users' access to different machines. A user can organize devices, users, and organizations using the platform's organizational management system.

In examples, parts themselves can include one or more resources. The most common types of resources are components, services (e.g., tasks), and remotes, but other resources can be provided. Components are the physical pieces of the device (for example, motors, arms, or cameras). Services (e.g., tasks) are libraries providing algorithms or higher-level functionality (for example, navigation, SLAM, or object manipulation). Remotes are other parts of the device. Adding a remote to a part allows the user to treat any resource of the remote part as though it were local to the part, thus connecting them.

Components can have Types, which indicate the API for that component (for example, arm or motor). Components can also have Models (e.g., hardware make and model), which indicate which implementation should be used to actuate with them. For example, an arm component could be a UR5 or an xArm, and the appropriate implementation is indicated by selecting the corresponding Model. These component implementations can come from a few different sources. The most common models of a component will have implementations in RDK, which can be selected from the Model dropdown of the configuration UI, programmatically specified in the configuration, and/or otherwise identified. If the Model the user is working with is not supported in RDK, the user can write the user's own component driver in one of Viam's SDKs. For example, a component the user is using may have an existing Python library. In that case, the user could use the platform's Python SDK to wrap the existing component library in the platform's API for that component Type. If no library currently exists, the user can write a full driver for that component's API in the language of the user's choice, using the platform SDK for the programming language.

Upon part startup, the part (e.g., the part process, the RDK instance, etc.) uses the secret in its cloud configuration file to ask the platform (e.g., the Viam App, https://app.viam.com, etc.) for its device configuration. This can be performed by each part, by the master part for the device, or by any other suitable part. The received configuration can be parsed and processed section by section to identify values specified in the configuration fields, such as which remotes, components, services, and processes to use. Remotes represent a connection to another device part, wherein the other device part can represent only the device part or can represent the whole other device.

Initializing a remote can include establishing a network connection to that device using a communication protocol (e.g., a direct gRPC connection, a WebRTC connection using a gRPC connection, etc.). Once established, the part making the connection will request information from the remote part about what components and services it offers (resource discovery) and subsequently will treat those resources as it treats its own local resources. For example, a user connecting to this part will see the components and services as if they were a resource of this part. This allows for creating a single part that can handle or direct all operations/commands sent to it, even those components which belong to another part, providing for various network and compute topologies.

In these examples, both components and services can be part of the resource hierarchy, and the RDK can be packaged with a supported set of implementations (e.g., similar to drivers) for each component and service. The components can, by default, be initialized in the order they are specified in the configuration file (e.g., fetched from the cloud). In variants, changing the initialization order can use a dependency field (e.g., depends on field) to create dependency relationships between components. Initializing a component can consult the component subtype (e.g., “arm”) and the model of the component (e.g. “UR5e”) in the packaged registry, and use the respective library and associated configuration section to construct and configure the component instance. Each component will have access to the other components that the component depends on when the component is constructed. As components get reconfigured, the handle that one component has on another can be kept intact for uninterrupted use. Once components are initialized, service initialization begins (e.g., in the order that the services were listed in the configuration file).

In examples, authentication in the platform can be represented by an auth.State object. The authentication state object can be the source of truth for what resources an entity (e.g., part, component, user, platform, etc.) is authorized to access or manipulate. In a first variant, a user manually determines the authentication permissions. In an example, this can be done via a streamlined autho integration that uses cookies to carry session state. The session conveys the user's email or other identifier, which the system considers unique across the system. The system can enable Google Single Sign-On and/or other OAuth service, and can have email/password enabled.

Every device part can have a secret key that, when starting up the part process, the part uses to pull the configuration file from the platform (e.g., Viam app, from https://app.viam.com), to send logs from the device, and/or to perform other functionalities.

The part process can use: a JSON API, gRPC, another RPC, and/or other communication protocol to access the WebRTC signaling server (e.g., to answer peer-to-peer connections), a TLS certificate provided by the platform (e.g., to talk to other device parts in its same location), and/or other information.

In a specific example, authentication into gRPC can be performed by configuring the part process (e.g., Viam server) with a set of authentication handlers provided by the platform's RPC framework (e.g., go.viam.com/utils/rpc framework). Each handler is associated with a type of credential to handle (rpc.CredentialsType) and an rpc.AuthHandler which contains two methods: Authenticate and VerifyEntity. Authenticate is responsible for taking the name of an entity and a payload that proves the caller is allowed to assume the role of that entity. It returns metadata about the entity (e.g. an email, a user ID, or in the system's case, the device part ID). The framework then returns a JWT (e.g., JSON web token) to the client (e.g., the part process, the RDK) to use in subsequent requests. On those subsequent requests, the JWT is included in an HTTP header called Authorization with a value of Bearer. The framework then intercepts all calls and ensures that there is a JWT present in the header, it is cryptographically valid, and then hands it off to the VerifyEntity method which will pull metadata out of the JWT from Authenticate and return a value that represents the authenticated entity to use in the actual gRPC call. The value can be accessed via rpc.MustContextAuthEntity.

In examples, every call (e.g., received by the part, received by the platform, etc.) can be authorized before responding. This can be performed based on the auth.State (e.g., in the device context), by verifying a signature, or otherwise performed. Additionally or alternatively, in some cases, the authorization can be performed even without a call (e.g., without explicit data access). In these cases, the system can explicitly attempt to access the referenced data in order to invoke authorization primitives. In an illustrative example, this can be performed in the WebRTC signaling server. In this example, system wraps the provided rpc.WebRTCSignalingServer with a server.authorizingWebRTCSignalingServer, where for every host mentioned that wishes to either make an offer to start a connection or answer said offer, the system can do a lookup for the associated device part which invokes authorization for that part. Currently, a device part can connect to any other device part in the same organization; alternatively, connection access can be limited.

In examples, every device in the same location shares both a TLS certificate and a secret. A device part managed by the platform (e.g., viam.cloud; app.viam.com's device domain) receives both pieces of this information on startup and periodically asks if there is a new TLS certificate (once an hour). Using the TLS certificate, a part process (e.g., RDK) can host a secure server and use the certificate with mutual TLS to authenticate itself to other devices without having to send any secrets when on the same local network; this is accomplished by using multicast DNS or otherwise accomplished. If the other device cannot be found locally, a WebRTC connection or other connection can be established using the device's personal secret, not the location secret.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A robot, comprising:
a plurality of robot parts, each comprising:
a physical actuator; and
a processing system configured to:
host a response-request communication server configured to communicate with other robot parts within the plurality of robot parts using a response-request communication protocol; and
control the physical actuator based on actuator instructions, specific to the respective physical actuator, that are translated by the processing system from a standard instruction.

2. The robot of claim 1, wherein each processing systems of each robot part is further configured to host a response-request communication client configured to send requests to the response-request communication servers of other robot parts.

3. The robot of claim 1, wherein the response-request communication server of at least one robot part of the plurality of robot parts is configured to communicate with a remote computing system using the response-request communication protocol.

4. The robot of claim 3, wherein the remote computing system further comprises a web-based interface, wherein the standard instruction is received at the web-based interface and sent to the at least one robot part of the plurality of robot parts.

5. The robot of claim 3, wherein the remote computing system hosts a response-request communication server configured to communicate with the at least one robot part of the plurality of robot parts.

6. The robot of claim 1, wherein communication between the plurality of robot parts does not use a publication-subscription communication protocol.

7. The robot of claim 1, wherein communication between the plurality of robot parts only uses the response-request communication protocol.

8. The robot of claim 1, wherein the response-request communication protocol comprises at least one of gRPC or WebRTC.

9. The robot of claim 1, wherein the plurality of robot parts are mounted to a common physical base.

10. A robot, comprising:
a main robot part; and
a plurality of child robot parts connected to the main robot part, wherein each child robot part comprises:
a physical actuator; and
a processing system comprising:
a communications module configured to communicate with the main robot part using at least one of gRPC or WebRTC; and
an actuator module configured to translate actuator instructions in a standard syntax to actuator instructions specific to the physical actuator, wherein the actuator instructions are received using the communications module.

11. The robot of claim 10, wherein each communications module of each child robot part in the plurality of child robot parts hosts a server and a client.

12. The robot of claim 10, wherein communication between the main robot part and the plurality of child robot parts does not use a publication-subscription communication architecture.

13. The robot of claim 10, wherein communication between the main robot part and the plurality of child robot parts uses only response-request architectures, comprising at least one of gRPC or WebRTC.

14. The robot of claim 10, wherein the main robot part is connected to a remote computing system using at least one of gRPC or WebRTC.

15. The robot of claim 14, wherein the remote computing system comprises a web interface, wherein the actuator instructions in the standard syntax are received by the remote computing system via the web interface and are sent to the main robot part using at least one of gRPC or WebRTC.

16. The robot of claim 10, wherein the plurality of child robot parts comprise different physical actuators and different actuator modules, wherein a same actuator instruction in the standard syntax is converted to different actuator instructions specific to the respective physical actuator.

17. The robot of claim 10, wherein the main robot part comprises a main processing system configured to execute a set of robot logic for the robot, wherein the set of robot logic generates the actuator instructions in the standard syntax.

18. The robot of claim 10, wherein the plurality of child robot parts and the main robot part are physically mounted to a common physical base.

19. The robot of claim 10, wherein each physical actuator is connected to the respective processing system by a physical data connector.

20. The robot of claim 10, wherein the main robot part is physically connected to each of the plurality of child robot parts by a physical data connector.
